(19) United States
(12) Patent Application Publication
(10) Pub. No.: US 2002/0131419 A1
(43) Pub. Date: Sep. 19, 2002

(54) Packet switch apparatus and multicasting method

(76) Inventor: Hiroaki Tamai, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/902,839

(22) Filed: Jul. 11, 2001

(30) Foreign Application Priority Data
Mar. 19, 2001 (JP) 2001-078639

(51) Int. Cl. H04L 12/56; H04L 12/54

(52) U.S. Cl. 370/395.4; 370/428

(57) ABSTRACT

A packet switch apparatus is disclosed which can send a packet to paths at the respective, different output bit rates thereof without degrading the efficiency of used of a common memory. A storing part stores a packet in a free space of the common memory. An enqueuing part enqueues a pointer indicating the stored packet to queues corresponding to paths to which the packet is scheduled to be sent. A sending part dequeues the enqueued pointer for each of the queues corresponding to the paths and sends the packet indicated by the dequeued pointer to the paths corresponding to the queues at the respective transmission bit rate thereof. A discarding part discards, on a queue basis, pointers from a head thereof in which it is determined that the number of pointers enqueued exceeds a predetermined threshold value. An free-address management part sets the free space of the common memory occupied by the packet to a busy state, and changes the free space that is now in the busy state to a free space when the pointer indicating the packet is dequeued or discarded from all of the queues to which the packet is scheduled to be sent.

### BACKGROUND OF THE INVENTION

1. Field of the Invention

The present invention relates to packet switch apparatuses and multicasting methods, and more particularly, to a packet switch apparatus and a multicasting method in which a plurality of interfaces of different transmission bit rates, such as a LAN (Local Area Network) and a WAN (Wide Area Network), coexist.

2. Description of the Related Art

There is a packet switch apparatus as an apparatus that relays packets transported over various transmission paths. Examples of the transmission paths for packets are a LAN and a WAN, and may have mutually different transmission bit rates. The packet switch apparatus has a plurality of interfaces that respectively match the different transmission paths in order to relay the packets thereon.

There is a case where only a limited bit rate on a virtual transmission path between a service company for providing communication channels and a customer can be used by a contract made with each other. In order to realize such a service style, the packet switch apparatus is designed to have a function of ensuring an arbitrary band designated on a virtual transmission path. A packet is transferred to the virtual transmission path at the designated bit rate that depends on the ensured band.

The packet switch apparatus is capable of sending a packet in multicast transmission. In the multicast transmission of packets, the packet switch apparatus stores an input packet in a common memory, and transfers the input packet stored in the common memory to a plurality of paths (which include transmission paths for transporting packets including a virtual transmission path). When a packet stored in a space in the common memory is completely transferred to all paths to which the packet is to be sent, the packet switch apparatus releases the space in the common memory. The released space is placed as a free space, which can be used for storing a new packet.

The timings of transmitting packets to the paths are controlled by multicast queues, each being provided to the respective paths. An address pointer that indicates a packet scheduled to be sent is enqueued to each of the multicast queues related to the paths to which the packet is to be sent. The transmission timings of packets are controlled by dequeuing the address pointers queued to the multicast queues. When a larger number of address pointers than a given number is enqueued to a multicast queue, the enqueuing of address pointers is stopped for a predetermined period. When the enqueuing of address pointers is stopped, some address pointers are sequentially discarded from the tail of the multicast queue.

The packet switch apparatus is equipped with a multicast control circuit part for controlling multicast communications. A conventional multicast control circuit part will now be described.

FIG. 12 is a block diagram illustrating functions of a conventional multicast control circuit part. A multicast control circuit part 900 includes an address pointer management part 910, a multicast queue part 920, and a packet write management part 930.

The address pointer management part 910 manages a free address of a common memory. The address pointer management part 910 includes an address pointer return check register part 911, a free-address management FIFO (First In First Out) part 912, and a return check information management FIFO part 913. The address pointer return check register part 911 has an address pointer check register, which is used to recognize the address of a packet that has been sent to the paths to which the packet is scheduled to be sent. The free-address management FIFO part 912 manages the addresses of free spaces in the common memory. The return check information management FIFO part 913 receives an address pointer that is a comparison target used in the address pointer return check register 911, and sends it to the free-address management FIFO part 912.

The multicast queue part 920 has a plurality of multicast queues 921-924, and a common scheduler 925. Each of the multicast queues 921-924 is provided to a respective path. The address pointer that indicates a packet to be sent to the paths is enqueued to the corresponding multicast queues 921-924. The common scheduler 925 manages the transmission timings of the packets enqueued to the multicast queues 921-924.

The packet write management part 930 receives a notification from the address pointer management part 910, and issues a write instruction by which an input packet can be written to the common memory.

In the packet switch apparatus having the above-mentioned multicast control circuit part 900, when a packet to be multicast is applied thereto, the address pointer management part 910 is notified of information about a path or paths to which the packet should be sent. Then, the free-address management FIFO part 912 notifies the packet write management part 930 of the address of a free space of the common memory into which the packet should be written. Simultaneously, the free-address management FIFO part 912 enqueues the address pointer in each of the multicast queues corresponding to the designated paths to which the packet should be sent.

Further, the free-address management FIFO part 912 notifies the return check information management FIFO part 913 of information that indicates which multicast queue the address pointer has been enqueued to. The multicast queues 921-924 dequeue the address pointers located at the heads thereof at the timings designated by the common scheduler 925, and instruct the packets indicated by the dequeued address pointers to be sent out. The multicast queues 921-924 notify the address pointer return check register 911 that the address pointers have been dequeued.

The return check information FIFO management part 913 sequentially passes information sent by the free-address management FIFO part 912 to the address pointer check register. The information is passed at the same time as the address pointers are returned to the free-address management FIFO part 912 from the address pointer return check register 911.

When the address pointers are enqueued to the multicast queues 921-924 from the free-address management FIFO part 912, the number of address pointers that have been enqueued may become excessive, and address pointers cannot be enqueued any more. In this case, the multicast queue part 920 discards some address pointers and notifies the address pointer return check register 911 that these address pointers have been discarded.

The address pointer return check register 911 compares the information supplied from the return check information management FIFO part 913 with the information supplied from the multicast queue part 920. If the information from part 913 matches that from part 920, the address pointer return check register 911 returns the address pointers to the free-address management FIFO part 912. Then, the free-address management FIFO part 912 stores the returned address pointers as free-address pointers. The address pointers thus stored are sent to the packet write management part 930 and the multicast queue part 920 when packets are written into the common memory.

In the above-mentioned manner, the address pointers of free spaces in the common memory and the packet transmission timings are managed.

FIG. 13 is a diagram of a configuration of the multicast queue part 920 used in the conventional multicast control. The multicast queue part 920 shown in FIG. 13 has a structure of discarding address pointers from the tail ends of the queues when an excessive number of address pointers are enqueued.

The multicast queue part 920 also has a structure of sending a back pressure toward a preceding stage in order to prevent the address pointers from being discarded. The back pressure functions to notify a preceding-stage processing part that transmission of packets is stopped. The back pressure is enabled until packets can be received again.

As shown in FIG. 13, an address pointer 931 is sequentially enqueued to the multicast queues 921-924 of the multicast queue part 920. The multicast queues 921-924 have mutually different transmission bit rates. The common scheduler 925 dequeues the queued address pointers in accordance with a predetermined schedule. The packets stored in the memory spaces indicated by the dequeued address pointers are sent to the paths (output ports) corresponding to the multicast queues from which the address pointers are dequeued.

When the address pointers are dequeued frequently as compared to the enqueuing the address pointers, an increased number of address pointers is cumulated in the multicast queues. When the number of address pointers cumulated in a multicast queue exceeds a back pressure assert threshold value α0 toward the preceding stage, the back pressure is sent to the free address FIFO management part 912 (shown in FIG. 12) located at the preceding stage. The back pressure stops the address pointers from being enqueued. Then, the number of address pointers cumulated in the multicast queue decreases gradually. When the number of address pointers cumulated in the multicast queue becomes equal to or smaller than a back pressure negate threshold value β0 toward the preceding stage, sending the back pressure toward the preceding stage is stopped.

When it is required to send packets in real time, discarding of packets is performed rather than the back pressure. For example, when the number of address pointers cumulated in a multicast queues exceeds a queue flood discard initiation threshold value γ0, address pointers sent after that are not enqueued but discarded. Unless the address pointers are enqueued, the packets indicated by these address pointers are not sent.

In the above manner, the multicast queues manage sending the packets to the different paths having different transmission bit rates.

In the conventional technique, when there are differences in bit rate among the paths, a next packet can be sent after the previous packet is completely sent to the scheduled paths. Therefore, packets must be sent to all the paths at a transmission bit rate equal to the lowest one of the transmission bit rates of the paths.

It may be possible to improve the above sequence in such a way as to send the next packet to a high-bit-rate output path without waiting for completion of sending the previous packet to a low-bit-rate output path. However, when the common memory is employed, the address pointers cannot be reused until the address pointers are dequeued in each of all the paths. That is, the spaces of the common memory for storing packets cannot be released. Thus, if there is an output path having a transmission bit rate lower than the band of input packets, the address pointers will be exhausted. If available address pointers are exhausted, there is no way other than discarding input packets. This will cause input packets to be discarded in an output path having a transmission bit rate higher than the band of the input packets.

It may also be possible to reduce the queue flood discard initiation threshold value as the output bit rate is low in order to reduce the possibility of pointer address shortage. However, this will degrade the quality of information sent to an output path having a low bit rate and degrade the efficiency of use of the common memory.

### SUMMARY OF THE INVENTION

Taking the above into consideration, an object of the present invention is to provide a packet switch apparatus and a multicasting method capable of sending a packet to paths at the respective, different output bit rates thereof without degrading the efficiency of use of a common memory.

To accomplish the above object, according to the present invention, there is provided a packet switch apparatus sending a packet stored in a common memory to a plurality of paths having different bit rates, comprising: storing means for storing a packet to be sent to at least one path in a free space of the common memory; enqueuing means for enqueuing a pointer indicating said packet stored in the shared memory to queues corresponding to paths to which said packet is scheduled to be sent; sending means for dequeuing the pointer enqueued by said enqueuing means for each of the queues corresponding to the paths and sending the packet indicated by the pointer dequeued to the paths corresponding to the queues at the respective transmission bit rate thereof; discarding means for discarding, on a queue basis, pointers from a head thereof in which it is determined that the number of pointers enqueued by said enqueuing means exceeds a predetermined threshold value; and free-address management means for setting the free space of the common memory that is occupied by the packet to a busy state and changing the free space that is now in the busy state to a free state when the pointer indicating said packet is dequeued or discarded from all of the queues to which said packet is scheduled to be sent.

The above-mentioned objects of the present invention are also achieved by a multicasting method of sending a packet stored in a common memory to a plurality of paths having different bit rates, comprising the steps of: storing a packet to be sent to at least one path in a free space of the common memory; enqueuing a pointer indicating said packet stored in the shared memory to queues corresponding to paths to which said packet is scheduled to be sent; dequeuing the pointer enqueued for each of the queues corresponding to the paths and sending the packet indicated by the pointer dequeued to the paths corresponding to the queues; discarding, on a queue basis, pointers from a head thereof in which it is determined that the number of pointers enqueued exceeds a predetermined threshold value; and setting the free space of the common memory that is occupied by the packet to a busy state and changing the free space that is now in the busy state to a free space when the pointer indicating said packet is dequeued or discarded from all of the queues to which said packet is scheduled to be sent.

The above and other objects, features and advantages of the present invention will become apparent from the following detailed description when taken in conjunction with the accompanying drawings which illustrate preferred embodiments of the present invention by way of example.

### BRIEF DESCRIPTION OF THE DRAWINGS

FIG. 1 is a block diagram of the principles of the present invention;

FIG. 2 is a block diagram illustrating functions of a packet switch apparatus according to an embodiment of the present invention;

FIG. 3 is a diagram of a configuration of a memory switch;

FIG. 4 is a functional block diagram of a multicast control circuit part;

FIG. 5 is a diagram of an address pointer return check table;

FIG. 6 is a block diagram illustrating functions of a multicast queue part;

FIG. 7 is a flowchart of an address pointer return check process;

FIG. 8 is a flowchart of a free address FIFO process;

FIG. 9 is a flowchart of an enqueue process;

FIG. 10 is a flowchart of a dequeue process;

FIG. 11 is a block diagram of a packet switch apparatus according to an embodiment of the present invention;

FIG. 12 is a block diagram illustrating functions of a conventional multicast control circuit part; and

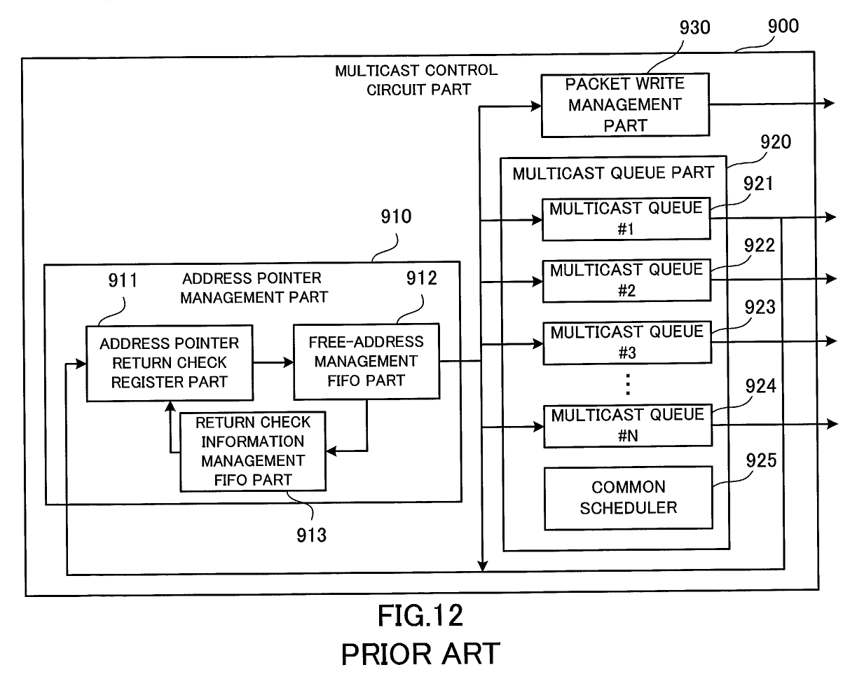

FIG. 13 is a diagram of a multicast queue part of a conventional multicast control system.

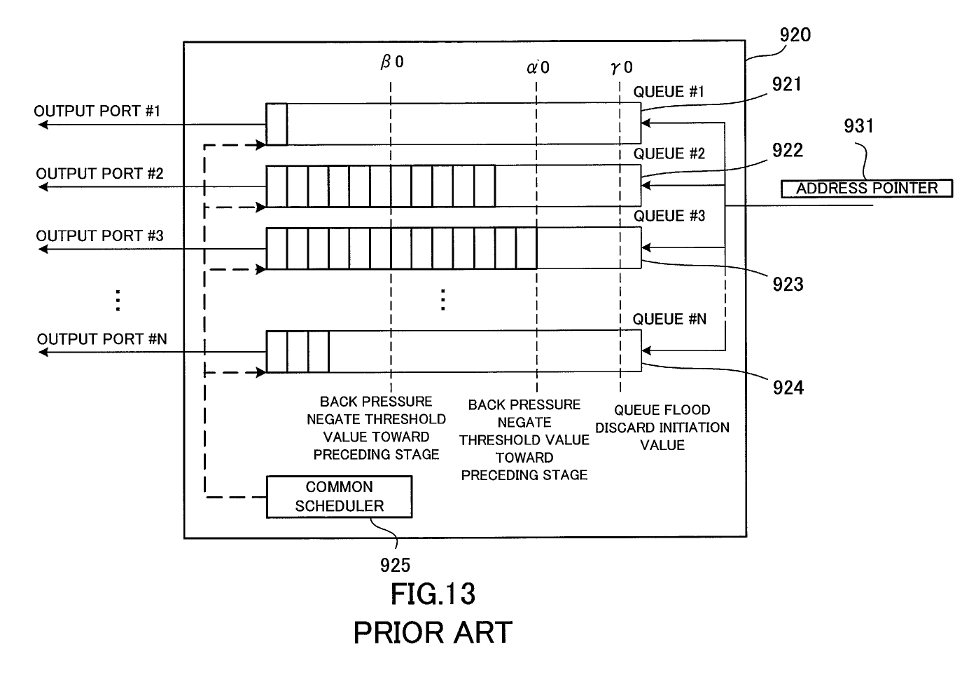

### DESCRIPTION OF THE PREFERRED EMBODIMENTS

A description will now be given of preferred embodiments of the present invention with reference to the accompanying drawings.

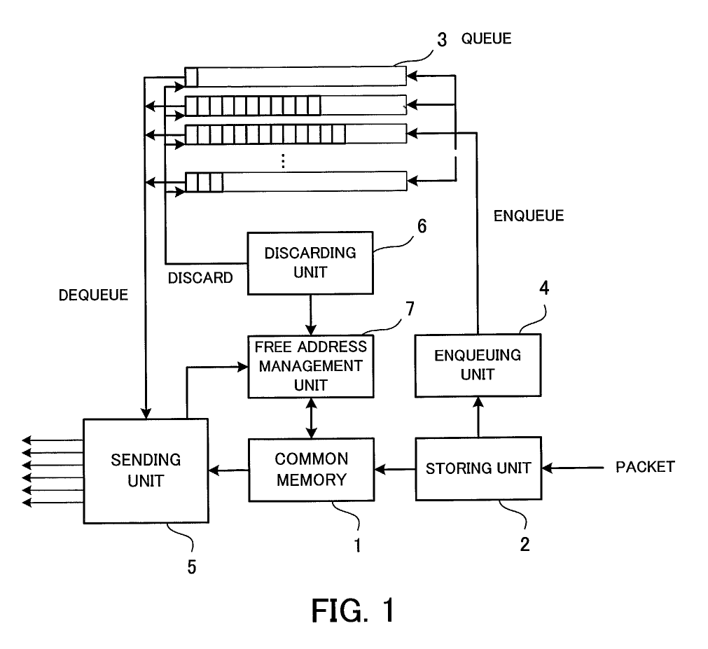

FIG. 1 is a diagram of the principles of the present invention. A packet switch apparatus according to the present invention includes a common memory 1, a storing unit 2, a plurality of queues 3, an enqueuing unit 4, a sending unit 5, a discarding unit 6, and a free-address management unit 7.

The common memory 1 is a recording medium for storing packets to be multicast. The storing unit 2 stores a packet to be sent to at least one path in a free space in the common memory 1. The plurality of queues 3 are capable of enqueuing pointers indicative of the individual packets and are provided to the respective transmittable paths. The enqueuing unit 4 enqueues the pointers to the queues corresponding to the paths to which the packets stored in the storing unit 2 are scheduled. Separate queues are provided for unicasting and multicasting. This is because a fault that occurs in a path that is one of the paths to which a packet is to be sent in multicast transmission affects transmission on other paths. Unicast transmission in the other paths is not affected by the fault due to the use of queues exclusively provided to unicast transmission. The sending unit 5 dequeues the pointers enqueued by the enqueuing unit 4 for each of the queues provided to the respective paths. Then, the sending unit 5 sends packets indicated by the dequeued pointers to the corresponding paths at the respective transmission bit rates thereof.

The discarding unit 6 determines, for each of the queues corresponding to the respective output ports, whether the number of pointers enqueued by the enqueuing unit 4 exceeds a predetermined threshold value. If the number of pointers exceeds the predetermined threshold value, the discarding unit 6 sequentially discards pointers starting from the head of the corresponding queue. The free-address management unit 7 sets the space of the common memory 1 in which a packet is actually stored by the storing unit 2 to a busy state. When the packet pointers are completely dequeued or discarded from all the queues corresponding to the output ports to which the packets are scheduled to be sent, the free-address management unit 7 changes the occupied space of the common memory 1 used for storing the original packet to a free space.

In operation, the storing unit 2 stores an input packet to be multicast in a free space of the common memory 1. Then, the enqueuing unit 4 enqueues a pointer indicating the input packet to queues corresponding to output ports to which the input packet should be sent. The enqueued pointers are dequeued from the queues by the sending unit 5, and the packets indicated by the dequeued pointers are sent to the output ports corresponding to the queues that are the dequeue targets at the transmission bit rates based on the paths.

If the number of pointers enqueued to a queue exceeds the predetermined threshold value, the discarding unit 6 discards pointers from the head of the queue. When all the pointers indicating the same packet are completely dequeued or discarded from the involved queues, the free-address management unit 7 changes the address of the space of the common memory 1 in which the above packet is stored to a free space.

Thus, the packets stored in the common memory 1 can be sent to the output ports at the respective transmission bit rates. If the number of pointers in a queue becomes excessive, pointers are discarded from the head of the queue. This makes it possible to send the next packet from a high-bit-rate queue to a corresponding path without waiting for completion of outputting packets from low-bit-rate queues. Further, it is possible to avoid occurrence of shortage of usable memory addresses due to a situation in which a low-bit-rate queue does not release the address pointer.

A detailed description will be given of an embodiment of the present invention. It is to be noted that the following description focuses upon the functions of multicast transmission in the packet switch apparatus. Also, all output ports that will appear in the following serve as paths to which multicast packets are sent.

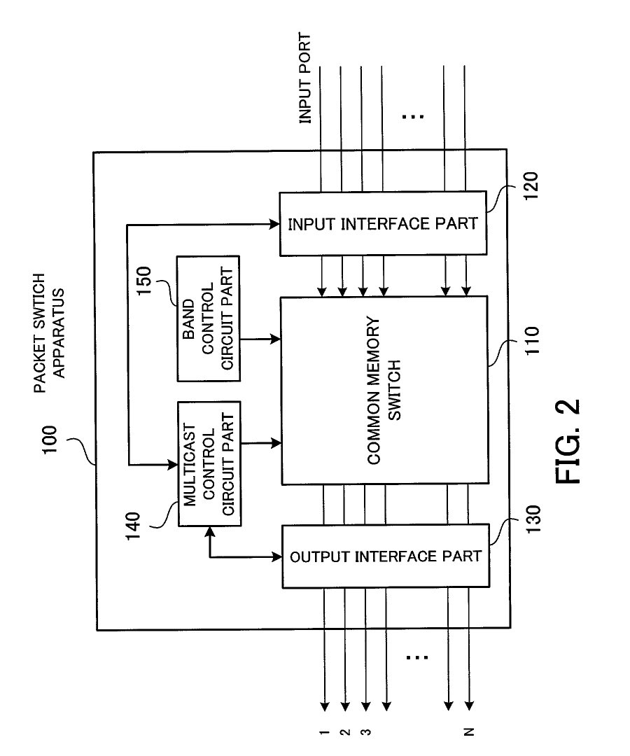

FIG. 2 is a block diagram illustrating functions of a packet switch apparatus according to an embodiment of the present invention. A packet switch apparatus 100 includes a common memory switch 110, an input interface part 120, an output interface part 130, a multicast control circuit part 140, and a band control circuit part 150.

The common memory switch 110 includes a common memory, and stores packets that are input via a plurality of input ports in the common memory. The common memory switch 110 sends packets stored in the common memory to output ports in accordance with an instruction supplied from the multicast control circuit part 140. The common memory switch 110 controls the bit rates at which packets are sent to output ports in accordance with an instruction from the band control circuit part 150.

The input interface part 120 has a plurality of input ports, and sends a request for acquiring an address for storing a received packet to the multicast control circuit part 140. The address acquisition request includes a queue identifier corresponding to at least one output port to which a packet is scheduled to be sent (the queue identifier corresponding to a port number of the output port). The input interface part 120 receives the address pointer from the multicast control circuit part 140, and stores the packet in the space of the common memory designated by the above address pointer.

The output interface part 130 fetches the packet from the common memory in the common memory switch 110 in accordance with the notification from the multicast control circuit part 140, and sends the packet to the scheduled output ports. In the example shown in FIG. 2, there are N output ports including a virtual transmission path (N is an integer).

The multicast control circuit part 140 manages the state of use of the common memory in the common memory switch 110. The multicast control circuit part 140 receives a request for acquiring an address pointer from the input interface part 120, and gives the address pointer that indicates a usable space in the common memory to the input interface part 120 in accordance with information in the address pointer acquisition request. The multicast control circuit part 140 controls the timings of sending packets by using the multicast queues for the respective output ports. When the timing of sending a packet in the common memory becomes available, the multicast control circuit part 140 passes the queue identifiers associated to the packet to be multicast and the address pointer of the packet to the common memory switch 110.

The band control circuit part 150 manages, for each output port, the band that depends on a contract made between the communication service company and customers. The band control circuit part 150 notifies the common memory switch 110 of information about the bands of the output ports, via which the packets can be sent at the respective bit rates.

A description will now be given of configurations of the common memory switch 110 and the multicast control circuit part 140.

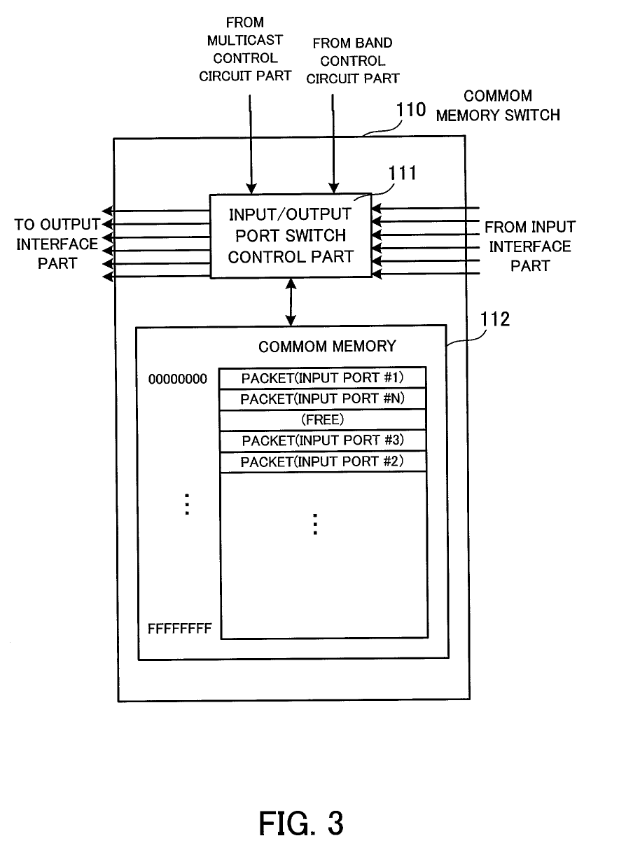

FIG. 3 is a block diagram of the common memory switch 110. The common memory switch 110 includes an input/output port switch control part 111, and a common memory 112.

The input/output port switch control part 111 receives a combination of a packet and an associated address pointer from the input interface part 120, and stores the packet at an address of the common memory 112 designated by the address pointer. Further, the input/output port switch control part 111 receives a combination of an address pointer and queue identifiers from the multicast control circuit part 140, and fetches the packet from the address of the common memory 112 indicated by the address pointer. Then, the switch control part 111 sends the packet to the output ports corresponding to the queue identifiers. The packet is sent in the bands defined by the band control circuit part 150.

The common memory 112 is a computer readable recording medium, such as a RAM. The packets that are input via the input interface part 120 are stored in the common memory 112. The packets received via the input ports are sequentially stored in free spaces of the common memory 112.

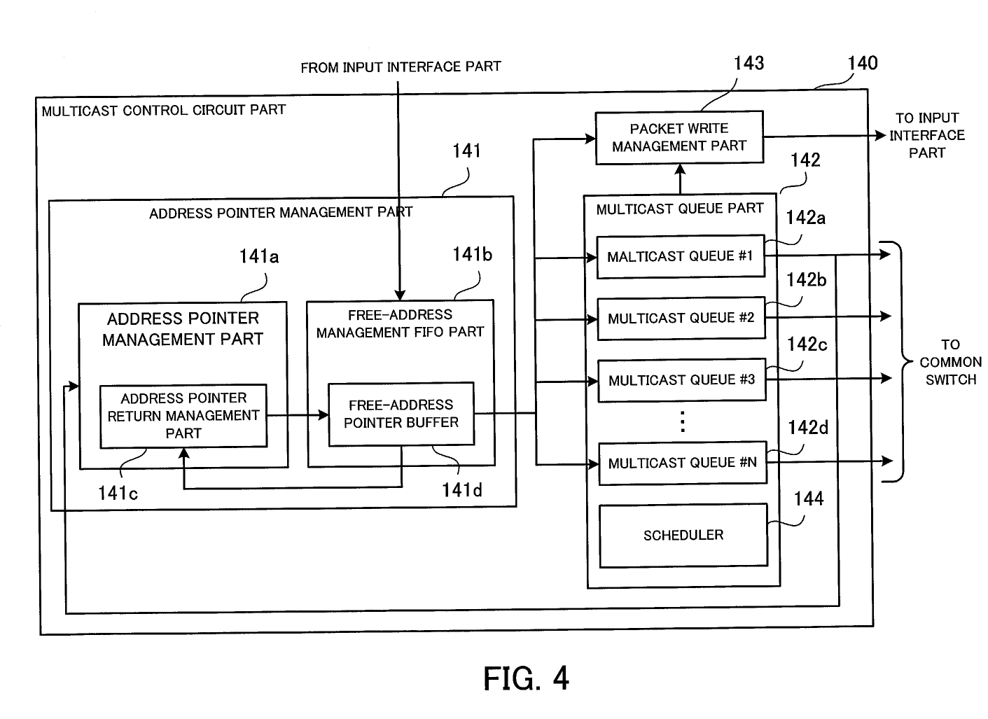

FIG. 4 is a functional block diagram of the multicast control circuit part 140, which includes and address pointer management part 141, a multicast queue part 142 and a packet write management part 143.

The address pointer management part 141 manages free addresses available in the common memory 112. The address pointer management part 141 includes an address pointer return management part 141a and a free-address management FIFO part 141b.

The address pointer return management part 141a includes an address pointer return check table 141c, and detects the addresses of free spaces (free addresses) available in the common memory 112 by using the table 141c. More specifically, the address pointer return management part 141a sets an address pointer return state for each of the output ports on the basis of information supplied from the multicast queue part 142 and the free-address management FIFO part 141b. When the address pointer has been returned from all the output ports, the address pointer return management part 141a determines that the memory space indicated by the address pointer is made free. Then, the address pointer return management part 141a passes the free-address pointer to the free-address management FIFO part 141b.

The free-address management FIFO part 141b includes a free-address pointer buffer 141d, and manages the addresses of free spaces in the common memory 112 by using the free-address pointer buffer 141d. More particularly, the free-address management FIFO part 141b sequentially stores the address pointers passed by the address pointer return management part 141a in the free-address pointer buffer 141d. The free-address management FIFO part 141b receives an address acquisition request for storing a packet from the input interface part 120, and fetches an address pointer from the free-address pointer buffer 141d by the FIFO technique. Then, the free-address management FIFO part 141b passes the fetched address pointer to the packet write management part 143. The free-address management FIFO part 141b enqueues the fetched address pointer to the multicast queues corresponding to the output ports to which the packet is scheduled to be sent.

The multicast queue part 142 includes a plurality of multicast queues 142a, 142b, 142c and 142d, which corresponding to respective output ports of transmission paths. For example, the multicast queue 142a corresponds to a first output port, and the multicast queue 142b corresponds to a second output port. The multicast queue 142c corresponds to a third output port, and the multicast queue 142d corresponds to an Nth output port. Address pointers of packets to be sent via the output ports are enqueued to the multicast queues 142a, 142b, 142c and 142d.

A scheduler group 144 includes schedulers, each provided to the respective multicast queues 142a, 142b, 142c and 142d. Each of the schedulers manages the transmission timing of the address pointer for the corresponding multicast queue on the basis of the state of transmission in the output interface part 130. The address pointer that is recognized to be now sent by the scheduler is dequeued from the corresponding multicast queue and is passed to the common memory switch 110 together with the queue identifier.

The packet write management part 143 receives the address pointer from the free-address management FIFO part 141b, and passes its address pointer to the input interface part 120. In this manner, an instruction to write the packet in the common memory 112 is generated.

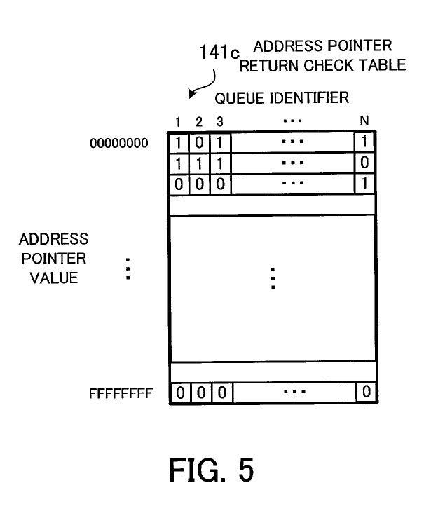

FIG. 5 is a diagram of an example of the address pointer return check table 141c. The address pointer return check table 141c uses the value of the address pointer as an offset for addressing, and has a bit arrangement equal to the bit width of the multicast queues. Each bit serves as a flag, which indicates whether the corresponding address pointer has been returned. In the example shown in FIG. 5, the address pointer values of the common memory 112 are allocated in the vertical direction of the address pointer return check table 141c, the queue identifiers being allocated in the horizontal direction. An alignment of flags corresponding to one address pointer value is called a return decision element.

The flags set in the address pointer return check table 141c indicate return information about the address pointers. For example, a flag value of “1” represents that the address pointer has been returned, and a flag value of “0” represents that the address pointer has not yet been returned.

When each of all the flags of the return decision element becomes “1”, it is meant that the address pointer corresponding to the return decision element has been returned from all the output ports.

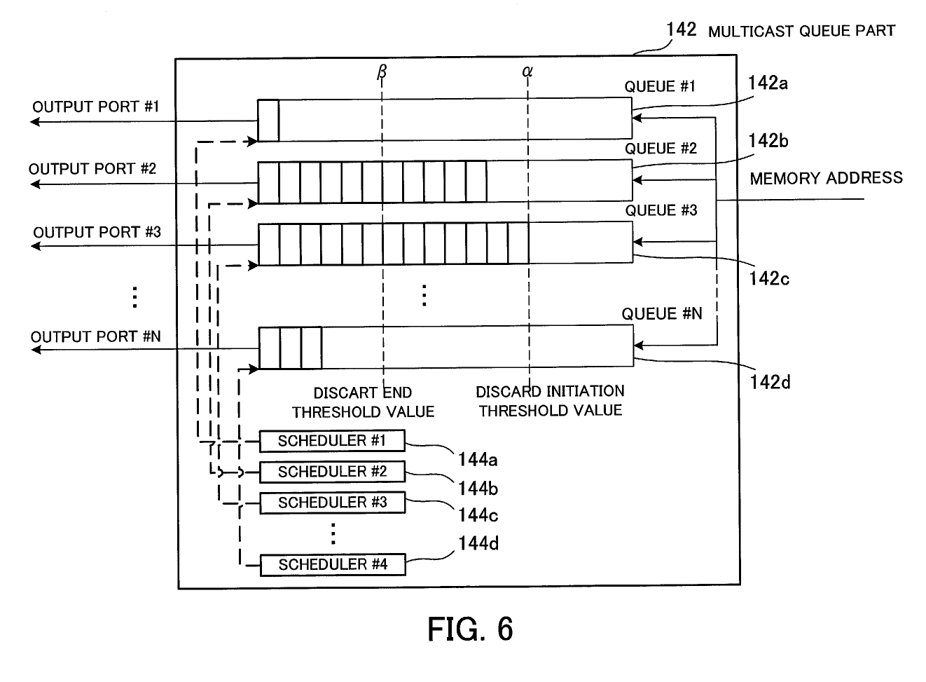

FIG. 6 is a block diagram illustrating functions of the multicast queue part 142, which includes schedulers 144a, 144b, 144c and 144d respectively corresponding to the multicast queues 142a, 142b, 142c and 142d. The schedulers 144a, 144b, 144c and 144d control the timings of dequeuing the address pointers of the multicast queues 142a, 142b, 142c and 142d. More particularly, when completion of sending the previous packet to the output port corresponding to the multicast queue is detected, the address pointer of the head of this multicast queue is dequeued therefrom. Although not illustrated, in a case where multicast communication and unicast communication take place at the same output port, the unicast communication may be given priority over the multicast communication. In such a case, the schedulers 144a, 144b, 144c and 144d control to put multicast transmission of packets on standby until unicast transmission is completed.

As shown in FIG. 6, a discard initiation threshold value α measured from the beginnings of the multicast queues 142a, 142b 142c and 142d and a discard end threshold value β measured therefrom are defined. When the numbers of address pointers cumulated in the multicast queues 142a-142d exceed the discard initiation threshold value α, address pointers are sequentially discarded from the beginnings of the multicast queues 142a-142d on the multicast queue basis. When the numbers of address pointers cumulated in the multicast queues 142a-142d become equal to or smaller than the discard end threshold value β, the multicast-queue-based discarding operation on the address pointers is ended.

A description will now be given of processes executed by the packet switch apparatus 100 configured as shown in FIGS. 2 through 6.

In the initial state, the packet switch apparatus 100 waits for arrival of a packet. The following process is executed in response to a packet sent by another apparatus connected to one of the input ports.

The input interface part 120 receives a packet that is input to an input port, and sends the address acquisition request to the multicast control circuit part 140. The address acquisition request contains the queue identifiers that indicate the output ports to which the received packet should be sent.

The address acquisition request is received by the free-address management FIFO part 141b provided in the address pointer management part 141 of the multicast control circuit part 140. The FIFO part 141b fetches the address pointer stored in the head of the free-address pointer buffer 141d. Then, the FIFO part 141b notifies the packet write management part 143 of the fetched address pointer. Further, the free-address management FIFO part 141b notifies the multicast queue part 142 and the address pointer return check table 141c of the combination of the queue identifier corresponding to the output port via which transmission is scheduled and the address pointer.

The packet write management part 143 notifies the input interface part 120 of the address pointer. The input interface part 120 stores the received packet in a space in the notified address pointer in the common memory 112. The multicast queue part 142 enqueues the address pointer received from the free-address management FIFO part 141b to each of the multicast queues corresponding to output ports to which the packets are scheduled to be simultaneously output. Among the flags in the return decision element corresponding to the address pointer received from the free-address management FIFO part 141b, the address pointer return check table 141c sets the flags related to the queue identifiers passed along with the address pointer to “1”.

The address pointer enqueued to the multicast queues is dequeued at the timings that match the bit rates of the output ports by the schedulers provided to the respective multicast queues. The common memory switch 110 is notified of the dequeued address pointer together with the queue identifiers by the multicast queue part 142. The common memory switch 110 that receives the address pointer fetches the packet stored in the space in the common memory 112 indicated by the address pointer, and sends the packet the output ports indicated by the queue identifiers.

The dequeued address pointer is sent to the address pointer return management part 141a by the multicast queue part 142. The address pointer return management part 141a specifies the return decision element by using the notified address pointer as an offset, and writes “1” in the bit position of the return decision element corresponding to the queue identifier (which shows the address pointer has been returned).

When the address pointers are cumulative in a multicast queue and the number of address pointers exceeds the discard initiation threshold value a, the multicast queue part 142 sequentially discards address pointers from the head of the multicast queue. In this case, the dequeue instruction from the scheduler is given priority over the discard process. The address pointer return management part 141a is notified of the discarded address pointer together with the queue identifier. The address pointer return management part 141a specifies the return decision element by using the address pointer as an offset, and writes “1” in the bit position of the return decision element corresponding to the queue identifier (which shows that the address pointer has been returned).

The address pointer return management part 141a returns the address pointer to the free-address management FIFO part 141b when all the bits of the return decision element show that the address pointers have been returned.

The above-mentioned operation makes it possible to send the next packet queued in a high-bit-rate queue without waiting for completion of sending the previous packet queued in a low-bit-rate queue. Further, when the number of address pointers enqueued to a multicast queue exceeds the discard initiation threshold value α, some packets are discarded from the head of the multicast queue until the number of address pointers becomes equal to or smaller than the discard end threshold value β. The above operation makes it possible to avoid occurrence of shortage of memory addresses due to a situation in which a low-bit-rate queue does not release the address pointer.

A description will be given of an address pointer return check process, a free address FIFO process, and a multicast queue control process.

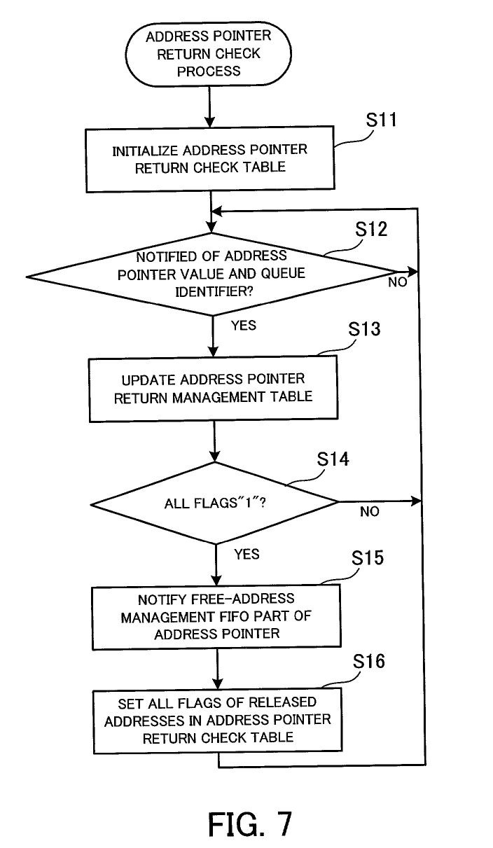

FIG. 7 is a flowchart of a sequence of the address pointer return check process, which will be described with reference to step numbers shown in FIG. 7.

[Step S11] The address pointer return management part 141a initializes the address pointer return check table 141c. More particularly, the management part 141a sets all the flags in the address pointer return check table 141c to “0”.

[Step S12] The address pointer return management part 141a determines whether it is notified of the address pointer value and the queue identifiers. For example, when the address pointer is dequeued from any of the multicast queues, the address pointer return management part 141a is notified of the combination of the queue identifier indicative of this multicast queue and the dequeued address pointer. The queue identifier is information consisting of bits equal in number to the number of output ports of the packet switch apparatus 100 (equal in number to the multicast queues). Each bit of the queue identifier is associated with the corresponding multicast queue, and only one of the bits is set to “1”. The bit of “1” of the queue identifier indicates the multicast queue designated by the present queue identifier.

The process proceeds with step S13 when the address pointer return management part 141a is notified of the address pointer value and the queue identifier. Step S13 is repeated until the management part 141a is not notified of the address pointer value and the queue identifier.

[Step S13] The address pointer return management part 141a updates the address pointer return check table 141c on the basis of the received address pointer value and queue identifier. More particularly, the address pointer return management part 141a reads the return decision element obtained when the received address pointer value is used as an offset. The address pointer return management part 141a performs an OR operation on the read return decision element and the queue identifier. Then, the management part 141a writes the result of the OR operation into the original place as a new return decision element.

[Step S14] The address pointer return management part 141a determines whether all of the flags of the return decision element written in step S13 are “1”. If the answer is YES, the process proceeds with step S15. If even one of the flags is “0”, the management part 141a executes step S12.

[Step S15] The address pointer return management part 141a notifies the free-address management FIFO part 141b of the address pointer corresponding to the return decision element in which all the flags are “1”. The above address pointer serves as a released, free address.

[Step S16] The address pointer return management part 141a sets all the flags of the return decision element related to the address released in step S15 to “0”. Then, the management part 141a executes step S12.

In the above-mentioned manner, a decision can be made on the output port basis as to whether the address pointer has been returned by using the address pointer return check table of the bit map format. When the address pointer has been returned from all the output ports, the corresponding address is released, and the free-address management FIFO part 141b is notified of the returned address pointer.

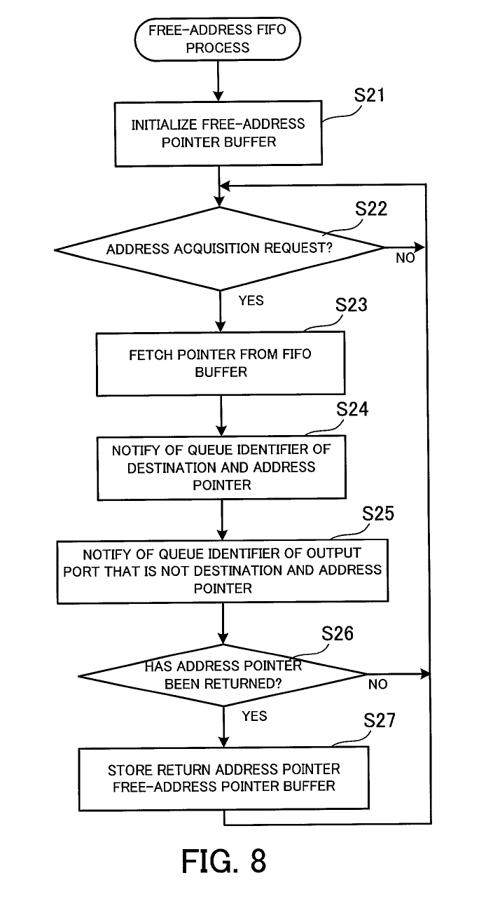

FIG. 8 is a flowchart of a sequence of the free address FIFO process, which will be described with reference to step numbers shown therein.

[Step S21] The free-address management FIFO part 141b initializes the free-address pointer buffer 141d. More particularly, the management FIFO part 141b deems all the spaces of the common memory 112 to be free and registers all the address pointers with the free-address pointer buffer 141d.

[Step S22] The free-address management FIFO part 141b determines whether an address acquisition request has been issued by the input interface part 120. If there is an address acquisition request, the process proceeds with step S23. If not, step S22 is repeated.

[Step S23] The free-address management FIFO part 141b fetches the address pointer from the head of the free-address pointer buffer 141d.

[Step S24] The free-address management FIFO part 141b notifies the packet write management part 143 of the address pointer, and notifies the multicast queue part 142 of the combination of the queue identifier of the destination and the address pointer.

[Step S25] The free-address management FIFO part 141b notifies the address pointer return management part 141a of the queue identifier of an output port that is not the destination and the address pointer.

[Step S26] The free-address management FIFO part 141b determines whether the address pointer has been returned from the address pointer return management part 141b. If the address pointer has been returned, the process proceeds with step S27. If the address pointer has not been returned, the management FIFO part 141b executes step S22.

[Step S27] The free-address management FIFO part 141b stores the address pointer returned from the address pointer return management part 141a in the tail of the free-address pointer. Then, the process returns to step S22.

In the above-mentioned manner, when a packet arrives at the packet switch apparatus 100, the parts related to this arrival are notified of the address pointer picked up in the FIFO formation as the packet storage destination. The released address pointer is stored in the free-address pointer buffer 141d.

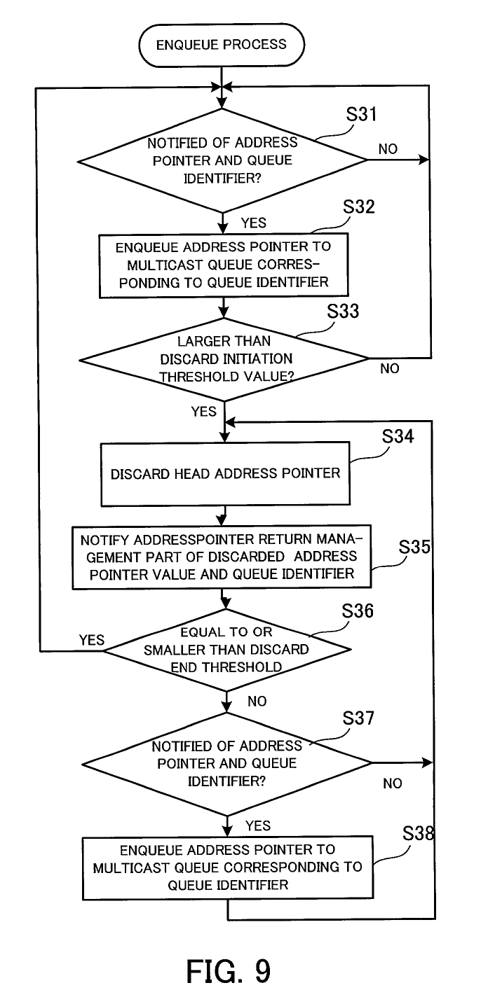

FIG. 9 is a flowchart of an enqueue process, which is individually executed for each of the multicast queues. The enqueue process will be described with reference to step numbers shown in FIG. 9.

[Step S31] The multicast queue part 142 determines whether it has been notified the address pointer and the queue identifier of the destination by the free-address management FIFO part 141b. If the answer is YES, the process proceeds with step S32. Besides, step S31 is repeated.

[Step S32] The multicast queue part 142 enqueues the address pointer to the multicast queues designated by the queue identifiers.

[Step S33] The multicast queue part 142 determines, as to the multicast queues to which the address pointer is enqueued, whether the number of address pointers exceeds the discard threshold value. If the answer is YES, the process proceeds with step S34. If the answer is NO, the process returns to step S31.

[Step S34] The multicast queue part 142 discards the address pointer located in the head of the multicast queue in which the number of address pointers exceeds the discard initiation threshold value.

[Step S35] The multicast queue part 142 notifies the address pointer return management part 141a of the discarded address pointer value and the queue identifier corresponding to the multicast queue in which the address pointer has been discarded.

[Step S36] The multicast queue part 142 determines whether the number of address pointers becomes equal to or smaller than the discard end threshold value. If the answer is YES, the process proceeds with step S37. If the number of address pointers is larger than the discard end threshold value, the multicast queue part 142 executes step S31.

[Step S37] The multicast queue part 142 determines whether it is notified of the address pointer and the queue identifier of the destination by the free-address management FIFO part 141b. If the answer is YES, the process proceeds with step S38. If not, the process returns to step S34.

[Step S38] The multicast queue part 142 enqueues the address pointer to the multicast queue designated by the queue identifier. Then, the process returns to step S34.

In the above-mentioned manner, the enqueue process of address pointers is carried out. If excessively many address pointers are registered with the multicast queues, the address pointers are discarded from the heads of the multicast queues.

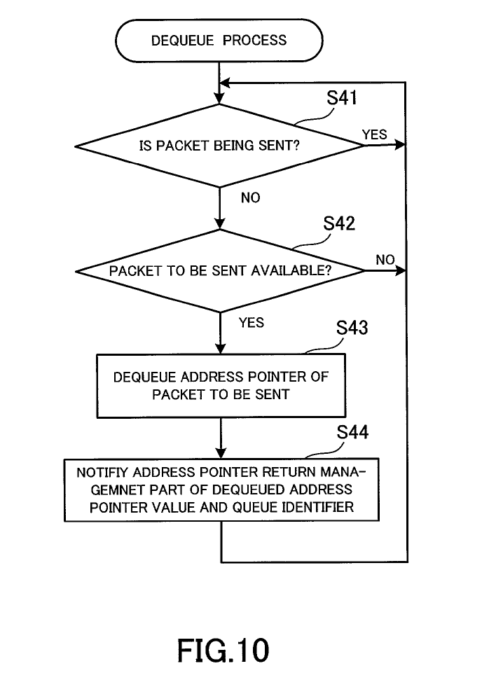

FIG. 10 is a flowchart of a dequeue process, which will be described with reference to step numbers shown therein.

[Step S41] Each of the schedulers in the multicast queue part 142 determines whether the corresponding output port is currently involved in sending a packet. If the corresponding output port is not engaged in sending a packet, the process proceeds with step S42. In contrast, if a packet is being sent via the corresponding output port, step S41 is repeated.

[Step S42] The scheduler determines whether there is the address pointer of a packet to be sent in the corresponding multicast queue. If such an address pointer exists in the multicast queue, the process proceeds with step S43. If the answer is NO, the scheduler returns to step S41.

[Step S43] The scheduler dequeues the address pointer registered in the head of the corresponding multicast queue.

[Step S44] The scheduler notifies the common memory switch 110 of the dequeued address pointer and the queue identifier corresponding to the multicast queue from which the address pointer has been dequeued, and returns to step S41.

In the above-mentioned manner, the address pointers registered with the multicast queues can sequentially be dequeued. The dequeued address pointers are sent to the common memory switch 110, so that the packets stored in the spaces designated by these address pointers can be sent to the output ports.

A description will now be given, by using a concrete example, of a data transfer state of a packet switch apparatus according to another embodiment of the present invention.

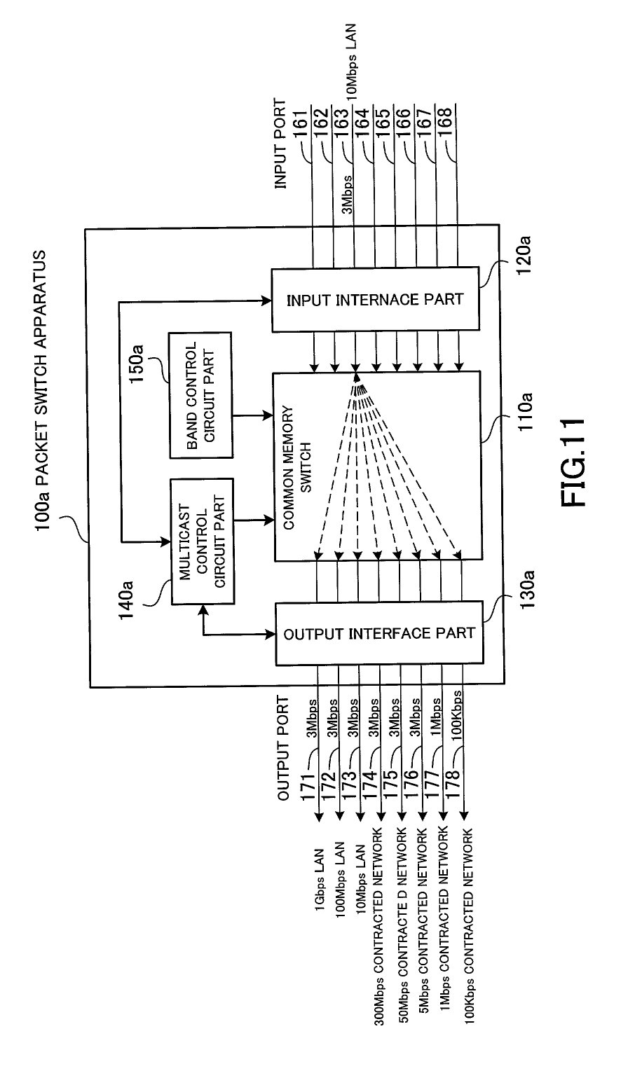

FIG. 11 is a block diagram of a packet switch apparatus according to an embodiment of the present invention. A packet switch apparatus 100a shown in FIG. 11 includes an interface having eight input ports 161-168, and another interface having eight output ports 171-178. The packet switch apparatus 100a has a common memory switch 110a, an input interface part 120a, an output interface part 130a, a multicast control circuit part 140a, and a band control circuit part 150a, which have the same functions as those of the common memory switch 110, the input interface part 120, the output interface part 130, the multicast control circuit part 140 and the band control circuit parts 150, respectively.

In the configuration shown in FIG. 11, a LAN communicable at 10 Mbps is connected to the input port 163. The output port 171 is connected to a LAN communicable at 1 Gbps, and the output port 172 is connected to a LAN communicable at 100 Mbps. The output port 173 is connected to a LAN communicable at 10 Mbps. The output port 174 is connected to a contracted network communicable at 300 Mbps, and the output port 175 is connected to a contracted network communicable at 50 Mbps. The output port 176 is connected to a contracted network communicable at 5 Mbps, and the output port 177 is connected to a contracted network communicable at 1 Mbps. The output port 178 is connected to a contracted network communicable at 100 Kbps. The contracted networks are WANs (Wide Area Networks) that contractible at an arbitrary transmission bit rate. The transmission bit rates can be controlled by the band control circuit part 150a.

A case is assumed where a 3 Mbps multicast packet flow is input via the input port 163 to which the 10 Mbps LAN is connected and is multicast to all the output ports 171-178.

When packets are transported to the input port 163 at 3 Mbps, the multicast control circuit part 140a determines available addresses of the common memory. Then, the packets are stored in the common memory in the common memory switch 110a.

The schedulers independently provided to the respective multicast queues in the multicast control circuit part 140a schedule the packets to the output ports 171-178. Since the output ports 171-176 have transmission bands equal to or greater than 3 Mbps, the 3 Mbps packets can be relayed to the output ports 171-176 without discarding packets.

In contrast, the output port 177 has a transmission band of 1 Mbps. Therefore, if the 3 Mbps multicast packet flow is continuously relayed to the output port 177, the number of address pointers will exceed the discard initiation threshold value α, which causes the address pointer discarding process to be started from the head of the multicast queue. A similar situation will occur for the output port 178 having the 100 Mbps transmission band. If the 3 Mbps multicast packet flow is continuously relayed to the output port 178, the number of address pointers will exceed the discard initiation threshold value α, which causes the address pointer discarding process to be started from the head of the multicast queue.

In the above manner, address pointers are discarded from the heads of the multicast queues associated to the output ports 177 and 178. Thus, the discarded address pointers can be promptly reused, and the address pointers with respect to the output ports 171-176 will never be short. Therefore, 3 Mbps communications can be ensured at an improved efficiency of use of the common memory.

A description will now be given of a difference between a process for discarding address pointers registered with the multicast queues from the tails thereof and an alternative process for discarding address pointers from the heads thereof as has been described with reference to the embodiments of the invention.

In the case where the number of enqueued address pointers exceeds the discard initiation threshold value, if the address pointer is discarded from the tail of the corresponding multicast queue, the same address pointer will be correctly enqueued with respect to the multicast queues that are not so many as the discard initiation threshold value. In that case, the address pointer that is enqueued to the multicast queues is not released until this address pointer is dequeued. Hence, shortage of the common memory cannot be efficiently avoided.

In contrast, if the address pointer is discarded from the heads of the multicast queues in the case where the number of enqueued address pointers exceeds the discard initiation threshold value, the present address pointer has already been dequeued as to the comparatively high-bit-rate output ports. Thus, the address pointer can be released promptly (in other words, the address pointer can be set to the free state promptly), so that the common memory can be used efficiently. This avoids shortage of the common memory.

In the above-mentioned manner, the same multicast packet flow can be sent to the output ports at the respective output bit rates. In other words, there is no need to change the output bit rate of a comparatively high-bit-rate output port to the bit rate of a comparatively low-bit-rate output port. It is therefore possible to realize multicast communications having qualities that match the bit rates of the output ports.

In addition, the address pointer is discarded from the heads of the multicast queues if the number of address pointers exceeds the discard initiation threshold value, so that shortage of the common memory can be avoided.

The return check of address pointers is performed using the table of the bit map format. This makes it possible to determine whether the address pointer has been returned from each output port by referring to ON/OFF of the flags provided to the respective output ports on the address pointer basis and to determine whether the memory space for storing the address pointer can be released.

The above-mentioned process functions can be implemented in a computer. In this implementation, the functions of the packet switch apparatus are described in a program recorded on a computer readable recording medium. Examples of the computer readable recording medium are a magnetic storage device and a semiconductor memory. The program may be placed in the market by recording the program on a portable recording medium such as a CD-ROM (Compact Disk Read Only Memory) or a floppy disk. It is also possible to store the program in a storage device of a computer connected to a network and transfer the same to another computer via the network. When the program is executed by the computer, the program is stored in a hard disk drive provided in the computer or the like, and is then loaded to the main memory therefrom.

As described above, according to the present invention, the packets stored in the common memory can be sent to the paths at the respective bit rates thereof. If the number of pointers becomes excessive, pointers are discarded from the heads of the queues. This makes it possible to allow the next packet to be sent from a high-bit-rate queue without waiting for completion of sending the packet from a low-bit-rate queue. In addition, it is possible to avoid shortage of available memory addresses due to a situation in which the low-bit-rate queue does not release the address pointer.

The foregoing is considered as illustrate only of the principles of the present invention. Further, since numerous modifications and changes will readily occur to those skilled in the art, it is not desired to limit the invention to the extract construction and application shown and described, and accordingly, all suitable modifications and equivalents may be regarded as falling within the scope of the invention in the appended claims and their equivalents.

What is claimed is:

1. A packet switch apparatus sending a packet stored in a common memory to a plurality of paths having different bit rates, comprising:
storing means for storing a packet to be sent to at least one path in a free space of the common memory;
enqueuing means for enqueuing a pointer indicating said packet stored in the shared memory to queues corresponding to paths to which said packet is scheduled to be sent;
sending means for dequeuing the pointer enqueued by said enqueuing means for each of the queues corresponding to the paths and sending the packet indicated by the pointer dequeued to the paths corresponding to the queues at the respective transmission bit rate thereof;
discarding means for discarding, on a queue basis, pointers from a head thereof in which it is determined that the number of pointers enqueued by said enqueuing means exceeds a predetermined threshold value; and
free-address management means for setting the free space of the common memory that is occupied by the packet to a busy state and changing the free space that is now in the busy state to a free state when the pointer indicating said packet is dequeued or discarded from all of the queues to which said packet is scheduled to be sent.

2. The packet switch apparatus according to claim 1, wherein said sending means comprises schedulers provided to the respective paths, said schedulers dequeuing the pointer enqueued by said enqueuing means.

3. The packet switch apparatus according to claim 1, wherein the paths include a virtual path to which an arbitrary output bit rate based on an ensured band is designated.

4. The packet switch apparatus according to claim 1, wherein said discarding means sets a discard initiation threshold value for each of the queues, and starts to discard pointers from one of the queues if the number of pointers enqueued to said one of the queues exceeds said discard initiation threshold value.

5. The packet switch apparatus according to claim 4, wherein said discarding means sets a discard end threshold value for each of the queues, and continues to discard pointers until the number of pointers enqueued to each of the queues becomes equal to or smaller than the discard end threshold value.

6. The packet switch apparatus according to claim 1, wherein said free-address management means manages status of enqueuing and dequeuing of pointers on the path basis by using a set of flags that is provided for each address of the common memory, the flags respectively corresponding to the paths.

7. The packet switch apparatus according to claim 1, wherein said free-address management means returns the address of the free space to the free state when said free-address management means turns ON all of the set of flags related to each of the paths, said all of the set of flags including a flag related to a path to which said packet is not scheduled to be sent, a flag related to a path to which said packet has been sent, and a flag related to a path in which the pointer indicating said packet has been discarded.

8. A multicasting method of sending a packet stored in a common memory to a plurality of paths having different bit rates, comprising the steps of:
storing a packet to be sent to at least one path in a free space of the common memory;
enqueuing a pointer indicating said packet stored in the shared memory to queues corresponding to paths to which said packet is scheduled to be sent;
dequeuing the pointer enqueued for each of the queues corresponding to the paths and sending the packet indicated by the pointer dequeued to the paths corresponding to the queues at the respective transmission bit rate thereof;
discarding, on a queue basis, pointers from a head thereof in which it is determined that the number of pointers enqueued exceeds a predetermined threshold value; and
setting the free space of the common memory that is occupied by the packet to a busy state and changing the free space that is now in the busy state to a free space when the pointer indicating said packet is dequeued or discarded from all of the queues to which said packet is scheduled to be sent.

9. The multicasting method according to claim 8, wherein the step of dequeuing said pointer dequeuing the pointer enqueued uses schedulers respectively provided to the paths.

10. The multicasting method according to claim 8, wherein the paths include a virtual path to which an arbitrary output bit rate based on an ensured band is designated.

11. The multicasting method according to claim 8, wherein the step of discarding pointers starts to discard pointers from one of the queues if the number of pointers enqueued to said one of the queues exceeds a discard initiation threshold value defined for each of the queues.

12. The multicasting method according to claim 11, wherein said step of discarding pointers comprises a step of setting a discard end threshold value for each of the queues, and continuing to discard pointers until the number of pointers enqueued to each of the queues becomes equal to or smaller than the discard end threshold value.

13. The multicasting method according to claim 8, wherein the step of setting an address comprises a step of managing status of enqueuing and dequeuing of pointers on the path basis by using a set of flags that is provided for each address of the common memory, the flags respectively corresponding to the paths.

14. The multicasting method according to claim 8, wherein the step of setting an address comprises a step of returning the address of the free space to the free state when turning ON all of the set of flags related to each of the paths, said all of the set of flags including a flag related to a path to which said packet is not scheduled to be sent, a flag related to a path to which said packet has been sent, and a flag related to a path in which the pointer indicating said packet has been discarded.
